(19) United States
(12) Patent Application Publication
(10) Pub. No.: US 2008/0143902 A1
(43) Pub. Date: Jun. 19, 2008

(54) Liquid crystal panel having common electrode connecting units in liquid crystal layer thereof

(75) Inventor: Tsu-Hsien Ku, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 12/002,362

(22) Filed: Dec. 17, 2007

(30) Foreign Application Priority Data
Dec. 15, 2006 (TW) 95147244

(51) Int. Cl. G02F 1/1333; G02F 1/1343

(52) U.S. Cl. 349/38; 349/139

(57) ABSTRACT

An exemplary liquid crystal display (LCD) panel includes a first substrate (210) includes a first glass plate (211) and a common electrode layer (212) formed at an inner surface of the first glass plate; a second substrate (200) parallel to the first substrate, the second substrate including a second glass plate (250), a number of parallel common lines (204) formed at an inner surface of the second substrate, and a number of pixel electrodes (205) formed at the inner surface of the second substrate and above the common lines, a liquid crystal layer sandwiched between the first substrate and the second substrate; and a number of conductive units (207) formed in the liquid crystal layer. The common electrode layer is directly and electrically connected to the common line via the conducting units.

### FIELD OF THE INVENTION

The present invention relates to a liquid crystal panel having two substrates and connecting units electrically connecting common electrodes and a common electrode layer of the two substrates.

### GENERAL BACKGROUND

A typical liquid crystal display (LCD) has the advantages of portability, low power consumption, and low radiation. LCDs have been widely used in various portable information products, such as notebooks, personal digital assistants (PDAs), video cameras and the like. Furthermore, the LCD is considered by many to have the potential to completely replace CRT (cathode ray tube) monitors and televisions.

Referring to FIG. 4, a typical liquid crystal panel 10 includes a first substrate 110, a second substrate 100 parallel to the first substrate 110, a sealant frame 120, a plurality of conductive metal balls 130 intermixed in the sealant frame 120, and a liquid crystal layer 140 sandwiched between the two substrates 110, 100. The substrates 110, 100 and the sealant frame 120 cooperatively form a space therebetween. The liquid crystal layer 140 is accommodated in the space.

The first substrate 110 includes a first glass plate 115, and a common electrode layer 111 formed at an inner surface of the first glass plate 115. The second substrate 100 includes a glass substrate 150, a plurality of thin film transistors 160, a plurality a common electrodes 170, an insulating layer 180, a semiconductor layer 181, and a plurality of pixel electrodes 190. Each TFT 160 includes a gate electrode 161, a source electrode 162, and a drain electrode 163.

The gate electrodes 161 and the common electrodes 170 are formed at an inner surface of the glass substrate 150. The gate electrodes 161 and the common electrodes 170 are parallel to each other, and alternately arranged. The insulating layer 180 is formed on the glass substrate 110, and covers the gate electrodes 161 and the common electrodes 170. The semiconductor layer 181 is formed on the insulating layer 180, at positions corresponding to the gate electrode 161. The source electrodes 162 and the drain electrodes 163 of the TFTs 160 are formed on the semiconductor layer 181. At each TFT 160, a channel 182 is defined between the source electrode 162 and the drain electrode 163, for exposing part of the semiconductor layer 181. The pixel electrodes 190 are formed on the glass substrate 150. The pixel electrodes 190 partly cover the drain electrodes 163 of the TFTs 160, and partly cover the insulating layer 180.

The common electrodes 170, the pixel electrodes 190 and the insulating layer 180 form a plurality of storage capacitors (not labeled). The common electrode layer 111, the pixel electrodes 190 and the liquid crystal layer 140 form a plurality of pixel capacitors (not labeled). When the liquid crystal panel 10 works, a common voltage is applied to the common electrode layer 111, and a plurality of gradation voltages are applied to the pixel electrodes 190. Voltage differences between the common electrode layer 111 and the pixel electrodes 190 are maintained by the pixel capacitors.

Because the capacitance of each pixel capacitor is generally determined by a dielectric constant of the liquid crystal layer 140, it is problematic to try to increase the capacitance of the pixel capacitors. Therefore it is necessary to provide the storage capacitors, for further maintaining the voltage differences between the common electrode layer 111 and the pixel electrodes 190. The common electrodes 170 need to be electrically connected to the common electrode layer 111, which is achieved via the conductive metal balls 130 and an external conducting line (not shown) connected in series.

Typically, the conductive metal balls 130 are non-uniformly distributed in the sealant frame 120. Therefore the electrical connection between the common electrodes 170 and the common electrode layer 111 may be faulty. In such case, a common voltage at the common electrodes 170 cannot be kept constant, and a flicker phenomenon is liable to occur and be manifest in images displayed by the liquid crystal panel 10. Furthermore, the conductive metal balls 130 are typically made of powdered metal particles. These particles can easily diffuse to other parts of the liquid crystal panel 10 and cause short circuits between two adjacent conducting lines in the liquid crystal panel 10. When this happens, the liquid crystal panel 10 is liable to malfunction, and defects may appear in the images displayed by the liquid crystal panel 10.

It is desired to provide an LCD which can overcome the above-described deficiencies.

### SUMMARY

In one preferred embodiment, a liquid crystal panel includes a first substrate includes a first glass plate and a common electrode layer formed at an inner surface of the first glass plate; a second substrate parallel to the first substrate, the second substrate including a second glass plate, a number of parallel common lines formed at an inner surface of the second substrate, and a number of pixel electrodes formed at the inner surface of the second substrate and above the common lines, a liquid crystal layer sandwiched between the first substrate and the second substrate; and a number of conductive units formed in the liquid crystal layer. The common electrode layer is directly and electrically connected to the common line via the conducting units.

Other novel features and advantages will become more apparent from the following detailed description when taken in conjunction with the accompanying drawings. In the drawings, all the views are schematic.

### BRIEF DESCRIPTION OF THE DRAWINGS

FIG. 1 is a top plan view showing certain structures of part of a liquid crystal panel according to a first embodiment of the present invention.

FIG. 2 is a side cross-sectional view of part of the liquid crystal panel of the first embodiment, corresponding to line II-II of FIG. 1.

FIG. 3 is similar to FIG. 2, but showing a corresponding view in the case of a liquid crystal panel according to a second embodiment of the present invention.

FIG. 4 is an abbreviated, side cross-sectional view of a conventional liquid crystal panel.

### DETAILED DESCRIPTION OF PREFERRED EMBODIMENTS

Reference will now be made to the drawings to describe various embodiments of the present invention in detail.

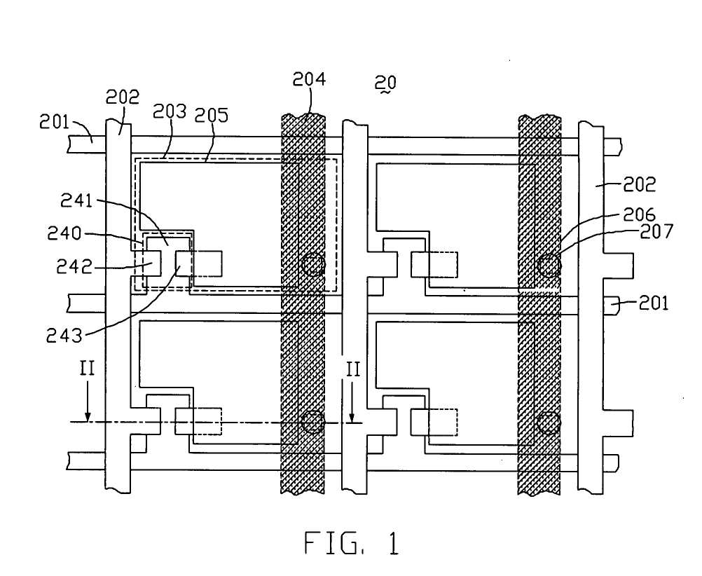

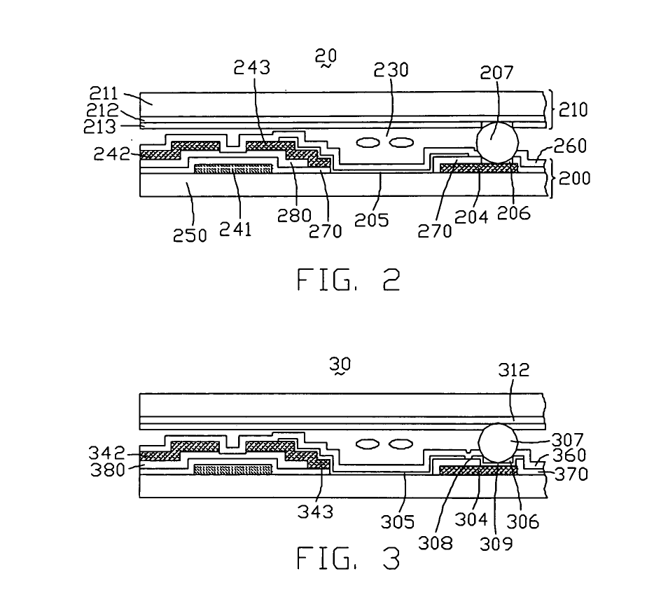

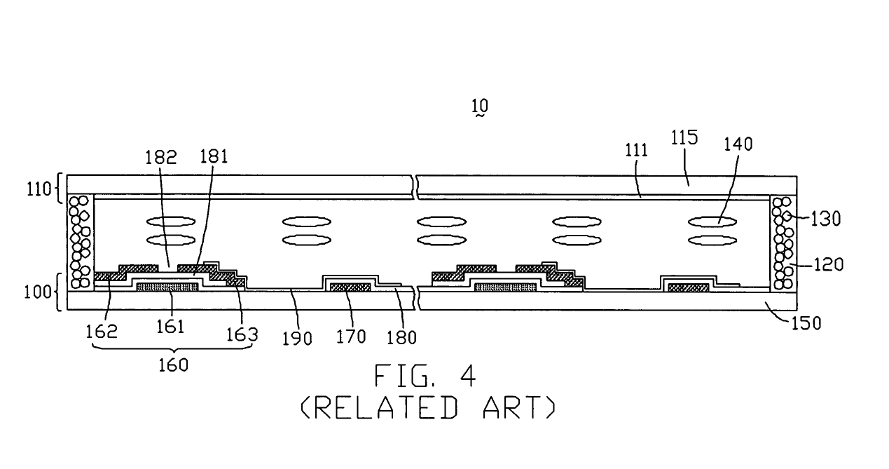

Referring to FIG. 1 and FIG. 2, certain parts of a liquid crystal panel 20 according to a first embodiment of the present invention are shown. The liquid crystal panel 20 includes a first substrate assembly 210, a second substrate assembly 200 parallel to the first substrate assembly 210, a liquid crystal layer 230 sandwiched between the two substrates 210, 200, and a plurality of conductive gold balls 207.

The first substrate assembly 210 includes a first glass plate 211, a first alignment layer 213, and a common electrode layer 212. The common electrode layer 212 is formed on an inner surface of the first glass plate 211 which faces toward the liquid crystal layer 230. The first alignment layer 213 is formed on the common electrode layer 212.

The second substrate assembly 200 includes a plurality of gate lines 201 parallel to each other, a plurality of data lines 202 parallel to each other and perpendicular to the gate lines 201, and a plurality of common lines 204. The common lines 204 are parallel to the data lines 202, and are alternately arranged with the data lines 202. The gate lines 201 and data lines 202 define a plurality of pixel regions 203, which are arranged in a grid (matrix). Each common line 204 passes through a respective column of the pixel regions 203. The common lines 204 are formed at an inner surface of the second glass plate 250 which faces toward the liquid crystal layer 230.

In each pixel region 203, the second substrate assembly 200 further includes a pixel electrode 205, a thin film transistor (TFT) 240 provided in the vicinity of a respective point of intersection of the gate lines 201 and the data lines 202, and a through hole 206 configured for receiving part of at least one of the conductive gold balls 207.

Each TFT 240 includes a gate electrode 241 connected to the gate line 201, a source electrode 242 connected to the data line 202, and a drain electrode 243 connected to the corresponding pixel electrode 205.

The second substrate assembly 200 further includes a second glass plate 250, a second alignment layer 260, an insulating layer 270, and a semiconductor layer 280. The gate electrodes 241 of the TFTs 240 and the common lines 204 are formed at the inner surface of the second glass plate 250. The insulating layer 270 is formed on the second glass plate 250, and covers the gate electrodes 241 of the TFTs 240 and the common lines 204. The semiconductor layer 280 is formed on the insulating layer 270, in positions corresponding to the gate electrodes 241. The source electrodes 242 and the drain electrodes 243 of the TFTs 260 are formed on the semiconductor layer 280.

In each pixel region 203, a channel (not labeled) of the TFT 240 is defined between the source electrode 242 and the drain electrode 243, above the gate electrode 241. The channel is for exposing part of the semiconductor layer 280. The pixel electrode 205 is formed on the second glass plate 250 and the insulating layer 270, and partly overlaps the drain electrode 243. The second alignment layer 260 covers the source and drain electrodes 242, 243 of the TFT 240, the pixel electrode 205, and part of the common line 204. The through hole 206 is formed in the insulating layer 270, exposing part of the common line 204 far from the drain electrode 243.

In the liquid crystal panel 20, the common lines 204, the pixel electrodes 205 and the insulating layer 270 form a plurality of storage capacitors (not labeled). The common electrode layer 212, the pixel electrodes 205 and the liquid crystal layer 230 form a plurality of pixel capacitors (not labeled).

The conductive gold balls 207 can be distributed to fit into the through holes 206 by ink-jet printing technology, wherein the conductive gold balls 207 are first melted. The melted conductive gold balls 207 are then cooled down. Subsequently, parts of the first alignment layer 213 and parts of the second alignment layer 260 which contact the conductive gold balls 207 can be displaced by rubbing the conductive gold balls 207 against the first alignment layer 213 and the second alignment layer 260. This is performed by applying a pressing force that presses the two substrates 210, 200 together. Simultaneously, the first substrate assembly 210 is rocked back and forth in horizontal directions relative to the second substrate assembly 200, such that the conductive gold balls 207 rub and displace portions of the first alignment layer 213 and the second alignment layer 260. Thus the conductive gold balls 207 become electrically connected to the respective common lines 204 and to the common electrode layer 212. That is, the common lines 204 are electrically connected to the common electrode layer 212 via the conductive gold balls 207. The storage capacitors are respectively connected in parallel to the pixel capacitors.

When the liquid crystal panel 20 works normally, a common voltage is applied to the common electrode layer 212 and the common lines 204, and a plurality of gradation voltages are applied to the pixel electrodes 205. Thus voltage differences are generated between the pixel electrodes 205 and the common electrode layer 212, and these voltage differences are maintained by the storage capacitors connected in parallel with the pixel capacitors. Electric fields perpendicular to the liquid crystal panel 20 are applied to the liquid crystal layer 230.

Because the conductive gold balls 207 are formed in the liquid crystal layer 230 and the common lines 204 are electrically connected to the common electrode layer 212 via the conductive gold balls 207, the electrical connection between the common lines 204 and the common electrode layer 212 is more reliable compared to the above-described conventional liquid crystal panel 10 that employs the non-uniformly distributed conductive metal balls 130. Thus the common voltage applied to the common lines 204 and the common electrode layer 212 can be reliably maintained at a constant value, and any flicker phenomena can be suppressed or even eliminated. Furthermore, the conductive gold balls 207 can be distributed in the through holes 206 by way of first melting the conductive gold balls 207. Thus the conductive gold balls 207 solidify as single metallic bodies respectively, and no powdered metal particles are formed. Accordingly, short circuits or other defects in the liquid crystal panel 10 due to the presence of powdered metal particles can be avoided.

Referring to FIG. 3, a liquid crystal panel 30 according to a second embodiment of the present invention is similar to the liquid crystal panel 20. However, a transparent conducting layer 309 is formed on part of an insulating layer 370 adjacent to a plurality of through holes 306, and is further formed on parts of a plurality of common lines 304 exposed by the through holes 306. A plurality of pixel electrodes 305 and the transparent conducting layer 309 are made in a same semiconductor process.

In each pixel region of the liquid crystal panel 30, an interval channel 308 is formed between the pixel electrode 305 and the transparent conducting layer 309. The interval channel 308 separates the pixel electrode 305 and the transparent conducting layer 309. At least one conductive gold ball 307 is provided at each through hole 306. The conductive gold ball 307 contacts a common electrode layer 312 and the transparent conducting layer 309, and thereby electrically interconnects the common electrode layer 312 and the common line 304. A second alignment layer 360 is formed on a source electrode 342, part of a semiconductor layer 380, a drain electrode 343, the pixel electrode 305, and the transparent conducting layer 309. The pixel electrodes 305 and the transparent conducting layer 309 are made of transparent material selected from the group consisting of ITO (Indium-Tin Oxide) and IZO (Indium-Zinc Oxide).

In alternative embodiments, the conductive gold balls 207, 307 can be formed at only some of the through holes 206, 306 of the pixel regions. For example, the conductive gold balls 207, 307 may be provided in odd-numbered columns only of the matrix of pixel regions, or in even-numbered columns only. In other examples, the conductive gold balls 207, 307 can be arranged in selected pixel regions according to any other suitable regular pattern.

In other alternative embodiments, a plurality of conductive gold balls 207 can be provided in each pixel region 203. The common lines 204 can be formed parallel to the gate lines 201. Each of the conductive gold balls 207, 307 can be instead another kind of suitable electrically conductive unit or mass.

It is to be further understood that even though numerous characteristics and advantages of preferred and exemplary embodiments have been set out in the foregoing description, together with details of the structures and functions of the embodiments, the disclosure is illustrative only; and that changes may be made in detail, especially in matters of shape, size and arrangement of parts within the principles of the present invention to the full extent indicated by the broad general meaning of the terms in which the appended claims are expressed.

What is claimed is:

1. A liquid crystal panel comprising:
a first substrate comprising a first glass plate and a common electrode layer formed at an inner surface of the first glass plate;
a second substrate parallel to the first substrate, the second substrate comprising a second glass plate, a plurality of parallel common lines formed at an inner surface of the second substrate, and a plurality of pixel electrodes formed at the inner surface of the second substrate above the common lines;
a liquid crystal layer sandwiched between the first substrate and the second substrate; and
a plurality of electrically conductive units formed in the liquid crystal layer, wherein the common electrode layer is electrically connected to the common lines via the conducting units.

2. The liquid crystal panel as claimed in claim 1, wherein the second substrate further comprises an insulating layer formed at the inner surface of the second glass plate and covering the common lines, and a plurality of through holes defined in the insulating layer corresponding to the common lines, the conducting units respectively partly received in the through holes.

3. The liquid crystal panel as claimed in claim 2, wherein the common lines, the pixel electrodes and the insulating layer form a plurality of storage capacitors, and the common electrode layer, the pixel electrodes and the liquid crystal layer sandwiched therebetween form a plurality of pixel capacitors connected in parallel to the plurality of storage capacitors, respectively.

4. The liquid crystal panel as claimed in claim 3, wherein an electrical field perpendicular to the glass plates between the common electrode layer and pixel electrodes is generated when the liquid crystal panel works normally.

5. The liquid crystal panel as claimed in claim 2, wherein the conducting units are conductive gold balls.

6. The liquid crystal panel as claimed in claim 2, wherein the conductive gold balls are partly received in the corresponding through holes by an ink-jet printing technology when the conductive gold balls are melted.

7. The liquid crystal panel as claimed in claim 2, wherein the second substrate comprises a plurality of gate lines parallel to each other, a plurality of data lines parallel to each other and perpendicular to the gate lines, a plurality of thin film transistors (TFTs) provided in the vicinity of intersections of the gate lines and the data lines, the gate lines and data lines defining a plurality of pixel regions.

8. The liquid crystal panel as claimed in claim 7, wherein each common line parallel to the data lines passes through the pixel regions arranged in one column.

9. The liquid crystal panel as claimed in claim 7, wherein each common line parallel to the gate lines passes through the pixel regions arranged in one row.

10. The liquid crystal panel as claimed in claim 7, wherein each pixel region has at least one through hole corresponding to the conducting unit.

11. The liquid crystal panel as claimed in claim 10, wherein the at least one conducting unit is partly received in each through hole.

12. The liquid crystal panel as claimed in claim 1, wherein the conducting units are partly received in the through holes in the pixel regions in odd-numbered columns of a matrix formed by the pixel regions.

13. The liquid crystal panel as claimed in claim 11, wherein the conducting units are partly received in the through holes in the pixel regions in even-numbered columns of a matrix formed by the pixel regions.

14. The liquid crystal panel as claimed in claim 7, wherein each TFT comprises a gate electrode connected to one of the gate lines, a source electrode connected to one of the data lines, and a drain electrode connected to a corresponding pixel electrode.

15. The liquid crystal panel as claimed in claim 7, further comprising a first alignment layer formed on the common electrode layer, and a second alignment layer formed on the pixel electrodes and the insulating layer, parts of the first alignment layer and parts of the second alignment layer which contact the conductive gold balls being displaced by rubbing the conductive gold balls against the first alignment layer and the second alignment layer.

16. The liquid crystal panel as claimed in claim 7, further comprising a transparent conducting layer formed on the common lines exposed by the through holes and on part of insulating layer adjacent to the through holes.

17. The liquid crystal panel as claimed in claim 16, wherein the pixel electrodes and the transparent conducting layer are made of the transparent material selected from the group consisting of ITO (Indium-Tin Oxide) and IZO (Indium-Zinc Oxide).

18. A liquid crystal panel comprising:
a first substrate;
a second substrate parallel to the first substrate,
a liquid crystal layer sandwiched between the first substrate and the second substrate;
a common electrode layer formed at an inner side of the first substrate;
a plurality of parallel common lines formed at an inner side of the second substrate;
a plurality of pixel electrodes formed at the inner side of the second substrate and partly overlapping the common lines; and
a plurality of electrically conductive units provided in the liquid crystal layer, wherein the common electrode layer is electrically connected to the common lines via the conducting units respectively.

19. The liquid crystal panel as claimed in claim 18, wherein the second substrate further includes an insulating layer formed on the glass plate for covering the common lines, a plurality of through holes defined in the insulating layer corresponding to the common lines, the conducting units respectively partly received in the through holes.

20. A liquid crystal panel comprising:
a first substrate comprising a first glass plate and a common electrode layer formed at an inner surface of the first glass plate;
a second substrate parallel to the first substrate, the second substrate comprising a second glass plate, a plurality of parallel common lines formed at an inner surface of the second substrate,
a liquid crystal layer sandwiched between the first substrate and the second substrate; and
a plurality of electrically conductive balls formed in the liquid crystal layer, wherein the common electrode layer is electrically connected to the common lines via the conducting units which is snugly disposed between said common electrode layer and said common lines.
